(19) United States
(12) Patent Application Publication
(10) Pub. No.: US 2021/0151909 A1
(43) Pub. Date: May 20, 2021

(54) CONNECTING DEVICE FOR CONNECTING AND GROUNDING COAXIAL CABLE CONNECTORS

(71) Applicant: PCT International, Inc., Tempe, AZ (US)

(72) Inventor: Timothy Lee Youtsey, Scottsdale, AZ (US)

(21) Appl. No.: 17/083,159

(22) Filed: Oct. 28, 2020

Related U.S. Application Data
(63) Continuation of application No. 16/556,500, filed on Aug. 30, 2019, now Pat. No. 10,855,003.
Application No. 16/556,500 is a continuation of application No. 15/972,014, filed on May 4, 2018, now Pat. No. 10,439,302.
(60) Provisional application No. 62/609,980, filed on Dec. 22, 2017.
(60) Provisional application No. 62/517,047, filed on Jun. 8, 2017.

(51) Int. Cl. H01R 9/05; H01R 43/20; H01R 13/6583; H01R 24/54

(52) U.S. Cl. CPC H01R 9/0512; H01R 43/20; H01R 9/0524; H01R 13/6598; H01R 13/6583; H01R 24/542; H01R 9/0527

(57) ABSTRACT

A connecting device configured to be installed on a first coaxial cable connector to facilitate connection of the first connector to a second connector and to maintain ground continuity across the connectors. In some embodiments, the connecting device includes a grounding element disposed in a gripping member, the grounding element including one or more projections configured to extend beyond an end of the gripping member to conductively engage an outer surface of the second connector.

### CROSS-REFERENCE TO RELATED APPLICATIONS

This application is a continuation of U.S. patent application Ser. No. 16/556,500, titled “CONNECTING DEVICE FOR CONNECTING AND GROUNDING COAXIAL CABLE CONNECTORS,” filed Aug. 30, 2019, now allowed, which is a continuation of U.S. patent application Ser. No. 15/972,014, titled “CONNECTING DEVICE FOR CONNECTING AND GROUNDING COAXIAL CABLE CONNECTORS,” filed May 4, 2018, now issued U.S. Pat. No. 10,439,302, which claims the benefit and of and priority to U.S. Provisional Patent Application No. 62/517,047, titled “CONNECTING DEVICE FOR CONNECTING AND GROUNDING COAXIAL CABLE CONNECTORS,” filed Jun. 8, 2017, and U.S. Provisional Patent Application No. 62/609,980, titled “CONNECTING DEVICE FOR CONNECTING AND GROUNDING COAXIAL CABLE CONNECTORS,” filed Dec. 22, 2017, the disclosures of which are incorporated herein by reference in their entireties.

### TECHNICAL FIELD

The following disclosure relates generally to devices for facilitating connection, reducing RF interference, and/or grounding of F-connectors and other cable connectors.

### APPLICATIONS INCORPORATED BY REFERENCE

Each of the following is incorporated herein by reference in its entirety: U.S. patent application Ser. No. 12/382,307, titled “JUMPER SLEEVE FOR CONNECTING AND DISCONNECTING MALE F CONNECTOR TO AND FROM FEMALE F CONNECTOR,” filed Mar. 13, 2009, now U.S. Pat. No. 7,837,501; U.S. patent application Ser. No. 13/707,403, titled “COAXIAL CABLE CONTINUITY DEVICE,” filed Dec. 6, 2012, now U.S. Pat. No. 9,028,276; U.S. patent application Ser. No. 14/684,031, titled “COAXIAL CABLE CONTINUITY DEVICE,” filed Apr. 10, 2015, now U.S. Pat. No. 9,577,391; and U.S. patent application Ser. No. 15/058,091, titled “COAXIAL CABLE CONTINUITY DEVICE,” filed Mar. 1, 2016, now U.S. Pat. No. 9,768,566.

### BACKGROUND

Electrical cables are used in a wide variety of applications to interconnect devices and carry audio, video, and Internet data. One common type of cable is a radio frequency (RF) coaxial cable (“coaxial cable”) which may be used to interconnect televisions, cable set-top boxes, DVD players, satellite receivers, and other electrical devices. A conventional coaxial cable typically consists of a central conductor (usually a copper wire), dielectric insulation, and a metallic shield, all of which are encased in a polyvinyl chloride (PVC) jacket. The central conductor carries transmitted signals while the metallic shield reduces interference and grounds the entire cable. When the cable is connected to an electrical device, interference may occur if the grounding is not continuous across the connection with the electrical device.

A connector, such as an “F-connector” (e.g., a male F-connector), is typically fitted onto an end of the cable to facilitate attachment to an electrical device. Male F-connectors have a standardized design, using a hexagonal rotational connecting ring with relatively little surface area available for finger contact. The male F-connector is designed to be screwed onto and off of a female F-connector using the fingers. In particular, internal threads within the connecting ring require the male connector to be positioned exactly in-line with the female F-connector for successful thread engagement as rotation begins. However, the relatively small surface area of the rotational connecting ring of the male F-connector can limit the amount of torque that can be applied to the connecting ring during installation. This limitation can result in a less than secure connection, especially when the cable is connected to the device in a location that is relatively inaccessible. As a result, vibration or other movement after installation can cause a loss of ground continuity across the threads of the male and female F-connectors. Moreover, the central conductor of the coaxial cable can often build up a capacitive charge prior to being connected to an electrical device. If the central conductor contacts the female F-connector before the male F-connector forms a grounded connection with the female F-connector, the capacitive charge can discharge into the electrical device. In some circumstances, the capacitive discharge can actually damage the electrical device.

Accordingly, it would be advantageous to facilitate grounding continuity across cable connections while also facilitating the application of torque to, for example, a male F-connector during installation.

### BRIEF DESCRIPTION OF THE DRAWINGS

Many aspects of the present disclosure can be better understood with reference to the following drawings. The components in the drawings are not necessarily to scale. Instead, emphasis is placed on clearly illustrating the principles of the present disclosure.

FIG. 1A is an isometric view of a coaxial cable assembly having a male connector, FIG. 1B is an isometric view of a female coaxial cable connector, and FIG. 1C is an isometric view of the male connector of FIG. 1A connected to the female connector of FIG. 1B.

FIG. 2 is a front isometric view of a connecting device configured in accordance with an embodiment of the present technology.

FIG. 3 is a rear isometric view of a jumper sleeve of the connecting device of FIG. 2 configured in accordance with an embodiment of the present technology.

FIG. 4 is a rear isometric view of a grounding element of the connecting device of FIG. 2 configured in accordance with an embodiment of the present technology.

FIG. 5A is a cross-sectional side view of the connecting device of FIG. 2, and FIG. 5B is an end view of the of the connecting device of FIG. 2.

FIG. 6A is a side view of the connecting device of FIG. 2 and the coaxial cable assembly of FIG. 1A prior to installation of the connecting device, and FIG. 6B is a partial cross-sectional side view of the connecting device and the coaxial cable assembly after installation of the connecting device in accordance with an embodiment of the present technology.

FIG. 7A is a partial cross-sectional side view of the coaxial cable assembly of FIG. 6B during connection to the female connector of FIG. 1B, and FIG. 7B is a side view of the coaxial cable assembly after connection to the female connector of FIG. 1B in accordance with an embodiment of the present technology.

FIG. 8 is a front isometric view of a connecting device configured in accordance with another embodiment of the present technology.

FIGS. 9A-9C are rear, front, and enlarged front isometric views, respectively, of a jumper sleeve of the connecting device of FIG. 8 configured in accordance with an embodiment of the present technology.

FIG. 10 is a side isometric view of a grounding element of the connecting device of FIG. 9 configured in accordance with an embodiment of the present technology.

FIG. 11A is a partially transparent front isometric view, and FIG. 11B is a partially transparent top cross-sectional view of the connecting device of FIG. 9.

FIG. 12A is a side view of the connecting device of FIG. 8 and the coaxial cable assembly of FIG. 1A prior to installation of the connecting device on the cable assembly, and FIG. 12B is a partial cross-sectional side view of the connecting device and the coaxial cable assembly after installation of the connecting device in accordance with an embodiment of the present technology.

FIG. 13A is a partial cross-sectional side view of the coaxial cable assembly of FIG. 12B during connection to the female connector of FIG. 1B, and FIG. 13B is a side view of the coaxial cable assembly after connection to the female connector of FIG. 1B in accordance with an embodiment of the present technology.

### DETAILED DESCRIPTION

The following disclosure describes devices, systems, and associated methods for facilitating connection of a first coaxial cable connector to a second coaxial cable connector, for maintaining ground continuity across coaxial cable connectors, and/or for reducing RF interference of a signal carried by one or more coaxial cables. For example, some embodiments of the present technology are directed to a connecting device having a jumper sleeve for easily connecting and disconnecting a male coaxial cable connector (“male cable connector”) to and from a female coaxial cable connector (“female cable connector”). The connecting device can further include a grounding element disposed at least partially in the jumper sleeve for establishing and/or maintaining ground path continuity between the male cable connector and the female cable connector before and after attachment. In some embodiments, the grounding element includes a conductive projection (e.g., a prong) that extends past an end of the jumper sleeve to conductively contact a portion of the female cable connector before the male cable connector contacts the female connector.

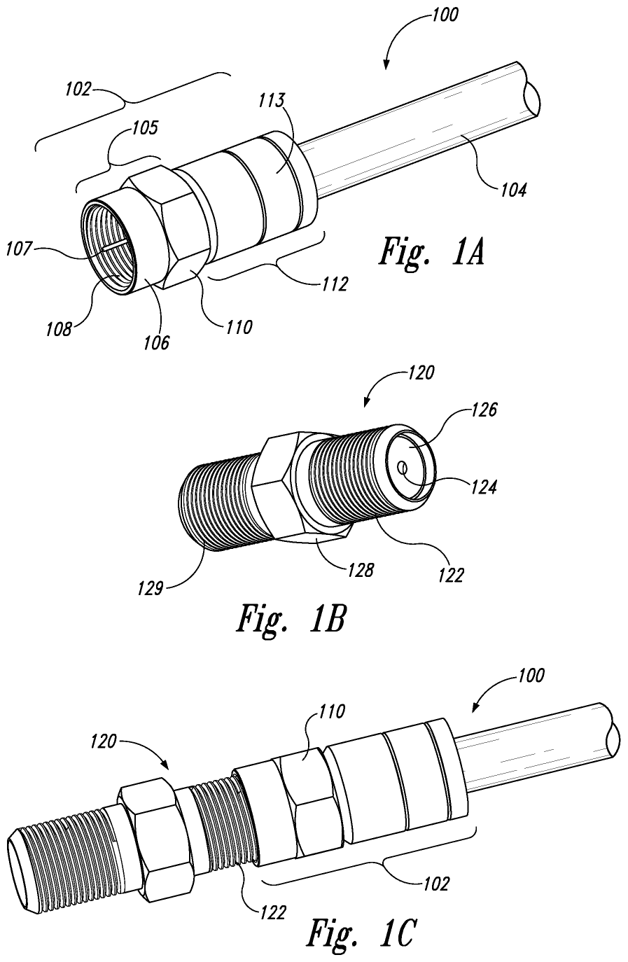

Certain details are set forth in the following description and in FIGS. 1A-13B to provide a thorough understanding of various embodiments of the disclosure. Those of ordinary skill in the relevant art will appreciate, however, that the technology disclosed herein can have additional embodiments that may be practiced without several of the details described below and/or with additional features not described below. In addition, some well-known structures and systems often associated with coaxial cable connector systems and methods have not been shown or described in detail below to avoid unnecessarily obscuring the description of the various embodiments of the disclosure.

The dimensions, angles, features, and other specifications shown in the figures are merely illustrative of particular embodiments of the disclosure. Accordingly, other embodiments can have other dimensions, angles, features, and other specifications without departing from the scope of the present disclosure. In the drawings, identical reference numbers identify identical, or at least generally similar, elements.

FIG. 1A is an isometric view of a conventional coaxial cable assembly 100 having a first connector 102 (e.g., a coaxial cable connector) attached to an end portion of a coaxial cable 104. The coaxial cable 104 has a central conductor 107. In the illustrated embodiment, the first connector 102 can be a male F-connector including a rotatable connecting ring 105 rotatably coupled to a sleeve 112. In other embodiments, however, the first connector 102 can be any suitable cable connector. The rotatable connecting ring 105 can have a threaded inner surface 108 and an outer surface having a first outer surface portion 106 and a second outer surface portion 110. The first outer surface portion 106 can have a generally circular cylinder shape, while the second outer surface portion 110 can have a plurality of flat sides forming, for example, a generally hexagonal shape (referred to herein as “hexagonal surface 110”). However, in other embodiments, the first and second outer surface portions 106, 110 can have different shapes and/or relative sizes, or the first outer surface portion 106 can be omitted. The sleeve 112 has an outer surface 113, and is pressed onto an exposed metal braid (not shown) on the outer surface of the coaxial cable 104 in a manner well known in the art.

FIG. 1B is an isometric view of a second connector 120 (e.g., a female F-connector) configured to be threadably engaged with the male F-connector 102 of the coaxial cable assembly 100 shown in FIG. 1A. More specifically, the female F-connector 120 has a first threaded outer surface 122 configured to engage the threaded inner surface 108 of the male F-connector 102, and an aperture 124 formed in a conductive receptacle 126. The aperture 124 is configured to receive the central conductor 107 of the male F-connector 102. In some embodiments, the female F-connector 120 can include other features, such as a hexagonal outer surface 128 and a second threaded outer surface 129. The hexagonal outer surface 128 can provide a gripping surface that facilitates the application of torque for threadably engaging the second threaded outer surface 129 with, for example, a coaxial cable connector for a television or other electronic device.

FIG. 1C is an isometric view of the coaxial cable assembly 100 of FIG. 1A with the male F-connector 102 threadably connected to the female F-connector 120. By way of example, a user can install the male F-connector 102 by applying torque to the hexagonal surface 110 of the male F-connector 102 to screw the male F-connector 102 onto the female F-connector 120. Once installed, the central conductor 107 is received in the aperture 124 and the threaded inner surface 108 of the male F-connector 102 engages the threaded outer surface 122 of the female F-connector 120 to provide a ground path between the connectors 102, 120. However, in some scenarios—for example, where the connectors 102, 120 are not properly aligned—the connection between the connectors 102, 120 can be less than secure after attachment. As a result subsequent vibration or movement can a cause a significant reduction or loss of ground continuity.

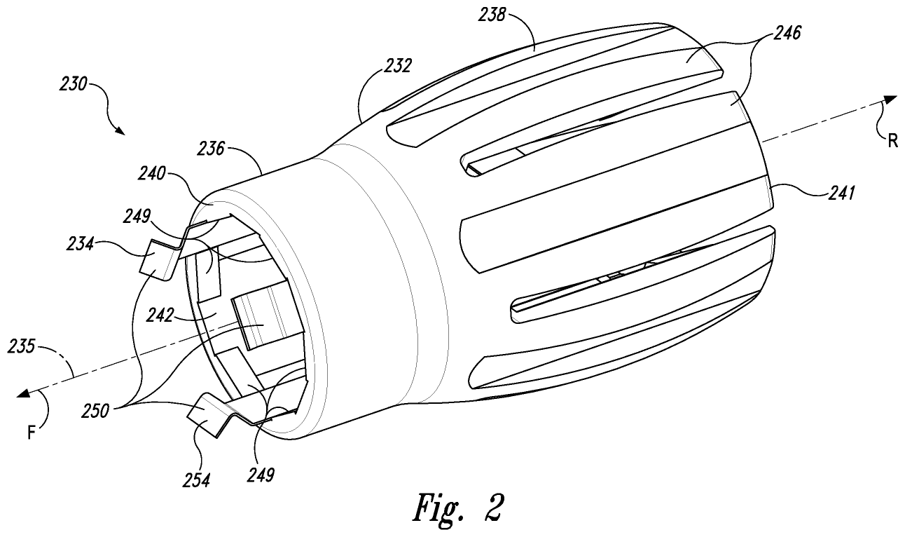

FIG. 2 is an isometric view of a connecting device 230 configured in accordance with an embodiment of the present technology. In the illustrated embodiment, the connecting device 230 includes a hollow gripping member, referred to herein as jumper sleeve 232, having a central axis 235 and configured to facilitate connection between two coaxial cable connectors. The jumper sleeve 232 includes a wrench portion 236 and a grip portion 238. The wrench portion 236 has a forward edge 240 and a shaped inner surface 242 configured to receive and at least partially grip an outer surface of a coaxial cable connector. For example, in the illustrated embodiment, the inner surface 242 has a complimentary hexagonal shape for snugly receiving the hexagonal surface 110 of the connecting ring 105 shown in FIG. 1A. In other embodiments, the inner surface 242 can have other shapes and features to facilitate receiving and/or gripping coaxial cable connectors having different shapes. As described in further detail below, the grip portion 238 extends from the wrench portion 236 toward a rear edge 241, and can have one or more grip members 246. The grip members 246 extend away from the wrench portion in a direction R, and can provide a gripping surface for applying torque to the rotatable connecting ring 105 of the male F-connector 102 received in the wrench portion 236. The jumper sleeve 232 and various aspects thereof can be at least generally similar to the jumper sleeves disclosed in U.S. patent application Ser. No. 12/382,307, titled “JUMPER SLEEVE FOR CONNECTING AND DISCONNECTING MALE F CONNECTOR TO AND FROM FEMALE F CONNECTOR,” filed Mar. 13, 2009, now U.S. Pat. No. 7,837,501; U.S. patent application Ser. No. 13/707,403, titled “COAXIAL CABLE CONTINUITY DEVICE,” filed Dec. 6, 2012, now U.S. Pat. No. 9,028,276; U.S. patent application Ser. No. 14/684,031, titled “COAXIAL CABLE CONTINUITY DEVICE,” filed Apr. 10, 2015, now U.S. Pat. No. 9,577,391; and U.S. patent application Ser. No. 15/058,091, titled “COAXIAL CABLE CONTINUITY DEVICE,” filed Mar. 1, 2016, now U.S. Pat. No. 9,768,566, each of which is incorporated herein by reference in its entirety.

The connecting device 230 also includes a grounding element 234 that can be removably or permanently installed at least partially within the jumper sleeve 232. The grounding element 234 is made from a conductive resilient material and includes one or more projections (which can also be referred to as tines, tangs, or prongs 250) that extend outward in a direction F at least partially beyond the forward edge 240 of the wrench portion 236. In the illustrated embodiment, for example, the grounding element 234 includes three prongs 250. Each prong 250 can have an elongate body extending generally parallel to the central axis 235 of the jumper sleeve 232, and an end portion 254 that extends at least partially beyond the forward edge 240 and radially inward toward the central axis 235. When the connecting device 230 is used to connect the male F-connector 102 to the female F-connector 120, as described below, at least a portion of each prong 250 conductively contacts at least a portion of the male F-connector 102, and the end portions 254 conductively contact at least a portion of the female F-connector 120 to maintain ground path continuity between the two connectors.

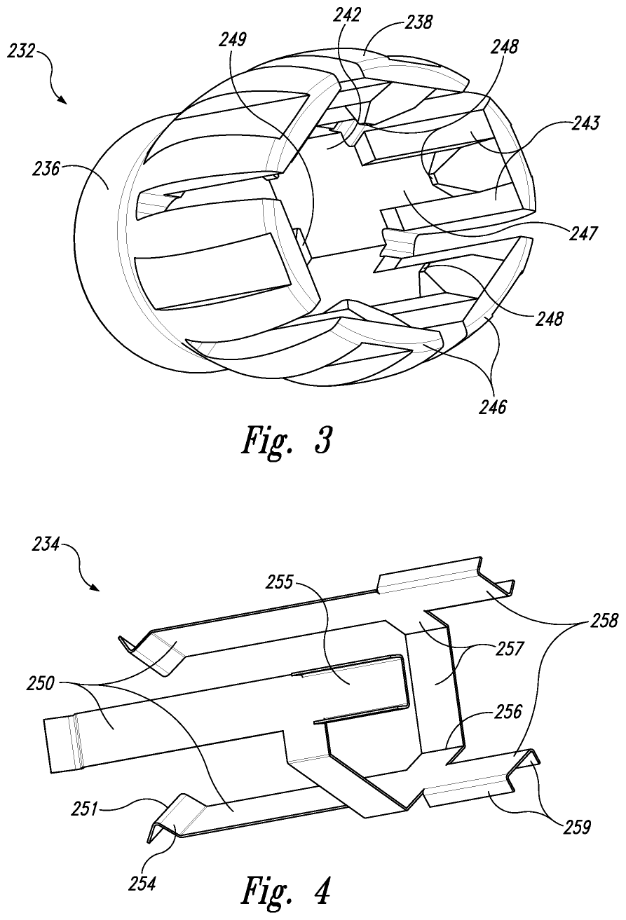

FIG. 3 is a rear isometric view of the jumper sleeve 232 prior to installation of the grounding element 234. In the illustrated embodiment, the grip portion 238 has a cask-shape with a plurality of (e.g., six) convex grip members 246 extending outwardly from the wrench portion 236. For example, the grip members 246 can be cantilevered from the wrench portion 236. In other embodiments, the grip portion 238 can include one or more grip members 246 having different shapes (e.g., concave, angular, etc.), and/or fewer or more than the six grip members 246 shown in FIG. 3. In some embodiments, individual grip members 246 can be omitted, and instead the grip portion 238 can include a single cylindrical member. When the male F-connector 102 (FIG. 1A) is inserted into the jumper sleeve 232, the grip members 246 allow for application of a greater torque to the rotatable connecting ring 105 than could otherwise be achieved by direct manual rotation of the hexagonal surface 110 of the male F-connector 102.

In the illustrated embodiment, each grip member 246 includes two recesses 243 on opposite sides of a raised surface 247, and a key portion 248 projecting inwardly from the raised surface 247 and toward the central axis 235 (FIG. 2). As described in further detail below, the raised surface 247 and recesses 243 are shaped and sized to selectively receive a portion of the grounding element 234. The key portions 248 are configured to abut a portion of the male F-connector 102 (e.g., an edge of the sleeve 112) to retain the male F-connector 102 in the jumper sleeve 232 and prevent the male F-connector 102 from moving out of the jumper sleeve 232 in the direction R (FIG. 2). Similarly, one or more shoulder portions 249 (best seen in FIG. 2) extend between adjacent “flats” of the hexagonal inner surface 242 proximate to the forward edge 240, and are configured to abut the forward edge of the connecting ring 105 to prevent the male F-connector 102 from moving out of the jumper sleeve 232 in the direction F (FIG. 2). The jumper sleeve 232 can be made from, for example, plastic, rubber, metal, and/or other suitable materials using methods well known in the art.

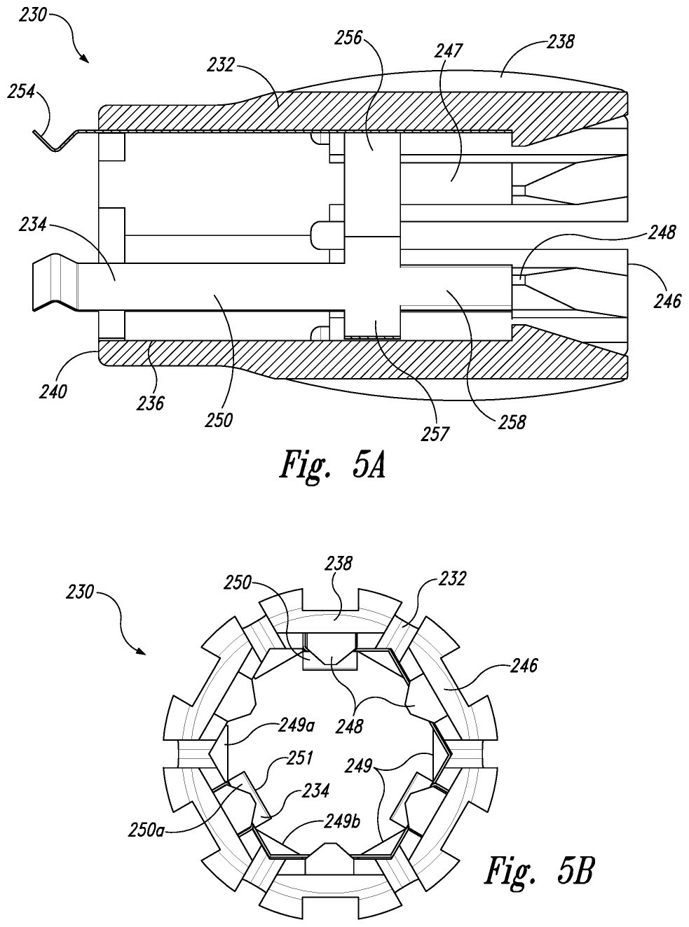

FIG. 4 is an isometric view of the grounding element 234 configured in accordance with an embodiment of the present technology. The grounding element 234 includes the prongs 250, a base portion 256, and one or more engagement features 258. More specifically, the base portion 256 can have a plurality of flat sides 257 forming, for example, a hexagonal shape to facilitate fitting within the complimentary recess in the jumper sleeve 232. In some embodiments, the base portion 256 does not form a continuous ring. For example, in the illustrated embodiment, the base portion 256 includes only five sides 257 such that the base portion 256 has an open hexagonal shape. In other embodiments, the base portion 256 can be formed to have any other suitable shape (e.g., a polygon, a circle, etc.), and can include any number of suitable sides. The prongs 250 extend outward away from the base portion 256, and the end portions 254 are shaped (e.g., bent) to extend inwardly. In some embodiments, the end portions 254 can have an angled or chevron-like shape profile including an apex 251 that is configured to engage the threaded outer surface 122 of the female F-connector 120 (FIG. 1B).

Each of the engagement features 258 can include one or more flanges 259 projecting radially outward from a web surface 255. The web surfaces 255 of the individual engagement features 258 are configured to snugly receive the raised surface 247 of a corresponding grip member 246 (FIG. 3), while the flanges 259 are configured to insert into the recesses 243 on the outer sides of the raised surface 247 to prevent rotational movement of the grounding element 234 relative to the jumper sleeve 232. Furthermore, outer edge portions of the individual engagement features 258 are positioned to abut the opposing face of the respective key portions 248 (FIG. 3). The key portions 248 can thereby prevent movement of the grounding element 234 in direction R relative to the jumper sleeve 232. In the illustrated embodiment, the grounding element 234 includes three prongs 250 longitudinally aligned with corresponding engagement features 258. In other embodiments, however, the prongs 250 and engagement features 258 can have different configurations (e.g., different numbers, alignment, and/or shapes).

In some embodiments, the grounding element 234 can be formed from a resilient conductive material, e.g., a metallic material, that is suitably elastic to flex in response to external forces experienced in use. In some such embodiments, the prongs 250, base portion 256, and/or engagement features 258 can be formed so that—when the grounding element 234 is not installed in the jumper sleeve 232—the grounding element 234 has a net outside diameter (or other cross-sectional dimension) that is slightly greater than the outside diameter of the mating surface of the jumper sleeve 232. This requires the grounding element 234 to be radially compressed slightly to fit within the jumper sleeve 232, and provides an outward spring bias against the jumper sleeve 232 to provide a snug fit of the grounding element 234. In other embodiments, the grounding element 234 can be secured within the jumper sleeve 232 via other means. For example, the grounding element 234 can be cast into, adhesively bonded, welded, fastened, or otherwise integrated or attached to the jumper sleeve 232 during or after manufacture. Moreover, in some embodiments, one or more of the prongs 250 can be formed so that they extend radially inward to contact (and exert a biasing force against) at least a portion of the male F-connector 102 and/or female F-connector 120 when the two connectors are engaged. The grounding element 234 can be made from any suitable conductive material such as, for example, copper beryllium, brass, phosphor bronze, stainless steel, etc., and can have any suitable thickness. For example, in some embodiments, the grounding element 234 can have a thickness of from about 0.001 inch to about 0.032 inch, or about 0.003 inch to about 0.020 inch. In some embodiments, each prong 250 can be integrally formed with a corresponding engagement feature 258, and/or the entire grounding element 234 can be formed from a single piece of conductive material. In other embodiments, the grounding element 234 can be formed from multiple pieces of material. Furthermore, although there is one grounding element 234 depicted in the illustrated embodiment, in other embodiments, two or more grounding elements 234 having the same or a different configurations may be positioned within the jumper sleeve 232.

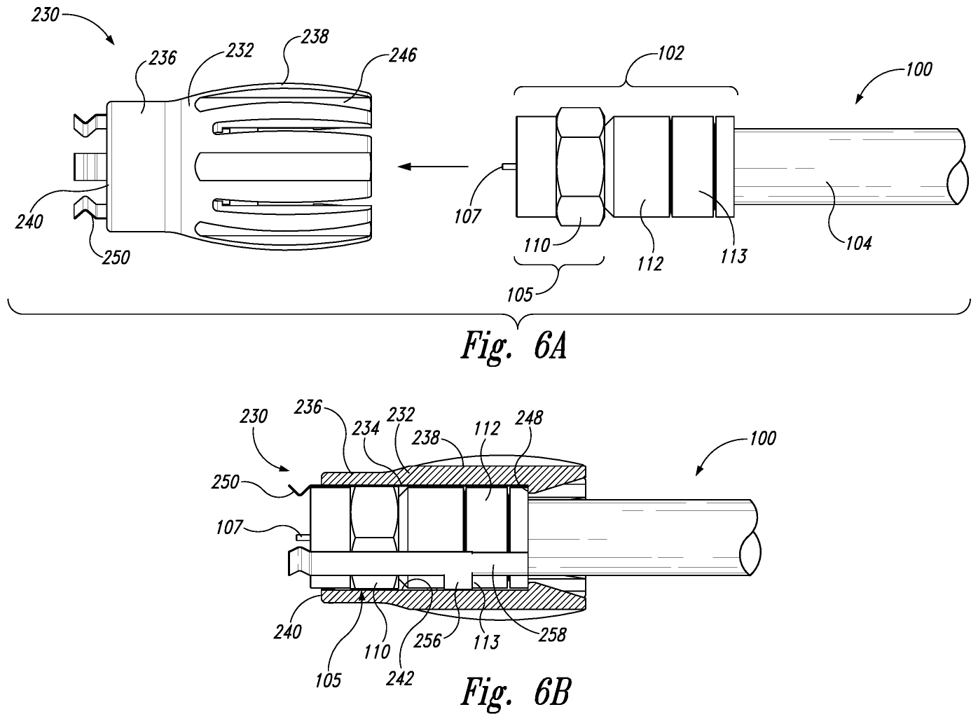

FIG. 5A is a cross-sectional side view of the connecting device 230 having the grounding element 234 installed in the jumper sleeve 232 in accordance with an embodiment of the present technology. As described above, the grounding element 234 is securely positioned within the jumper sleeve 232 (via, e.g., an interference fit) with the engagement features 258 for receiving the raised surfaces 247 of respective grip members 246. The base portion 256 can also be positioned within the grip portion 238 of the jumper sleeve 232. In some embodiments, the hexagonally arranged sides 257 of the base portion 256 press outward against the adjacent raised surfaces 247 of at least some of the grip members 246 to further secure the grounding element 234 within the jumper sleeve 232. The elongate body portions of the prongs 250 extend outward from the base portion 256 and beyond the forward edge 240 of the wrench portion 236 to position the end portions 254 outside of the wrench portion 236.

FIG. 5B is a rear end view of the connecting device 230 showing the grounding element 234 installed in the jumper sleeve 232. Each prong 250 can extend between a pair of adjacent shoulder portions 249. For example, in the illustrated embodiment, a first prong 250a extends between adjacent shoulder portions 249a and 249b. Thus, the shoulder portions 249 retain the male F-connector 102 within the jumper sleeve 232 without inhibiting the prongs 250 from extending outwardly of the jumper sleeve 232. Moreover, in the illustrated embodiment, the prongs 250 are equally spaced angularly around the central axis 235 of the jumper sleeve 232. Such a configuration can maximize the likelihood that ground continuity will be maintained between the connectors 102, 120 once they are connected using the connecting device 230, since any radial misalignment between the connectors 102, 120 will necessarily be towards at least one of the prongs 250. However, in some embodiments, the prongs 250 can have a different configuration (e.g., six prongs 250 each positioned adjacent a corresponding grip member 246, only one prong 250 positioned adjacent a single corresponding grip member 246, etc.).

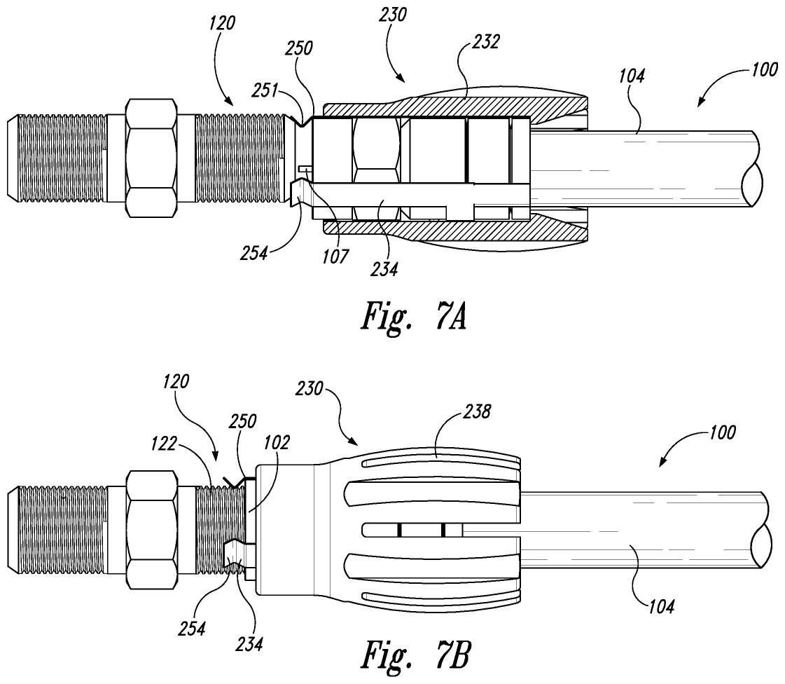

FIG. 6A is a side view of the coaxial cable assembly 100 and connecting device 230 prior to installation of the connecting device 230 onto the cable assembly 100. FIG. 6B is a side view of the coaxial cable assembly 100 and the connecting device 230 after installation of the connecting device 230. In FIG. 6B, the jumper sleeve 232 is shown in cross-section for clarity of illustration. Referring to FIGS. 6A and 6B together, during installation, the male F-connector 102 is fully inserted into the connecting device 230 so that the shaped inner surface 242 of the wrench portion 236 receives the hexagonal surface 110 of the connecting ring 105. The grip members 246 of the grip portion 238 can be flexed outward to allow the male F-connector 102 to be positioned within the connecting device 230. When the male F-connector 102 is fully inserted, the key portions 248 and the shoulder portions 249 (FIG. 5B) retain the male F-connector 102 in the connecting device 230.

As best seen in FIG. 6B, the grounding element 234 is positioned between the jumper sleeve 232 and the sleeve 112 and the connecting ring 105 of the male F-connector 102. In some embodiments, the base portion 256 and/or the engagement features 258 conductively engage and/or contact the outer surface 113 of the sleeve 112. Each prong 250 of the grounding element 234 conductively engages and/or contacts a corresponding one of the “flats” of the hexagonal surface 110 of the connecting ring 105 and the outer surface 113 of the sleeve 112 to maintain a metal-to-metal ground path throughout the male F-connector 102. Additionally, in this embodiment, each of the prongs 250 extends further outward beyond the forward edge 240 of the wrench portion 236 than the central conductor 107 of the coaxial cable 104.

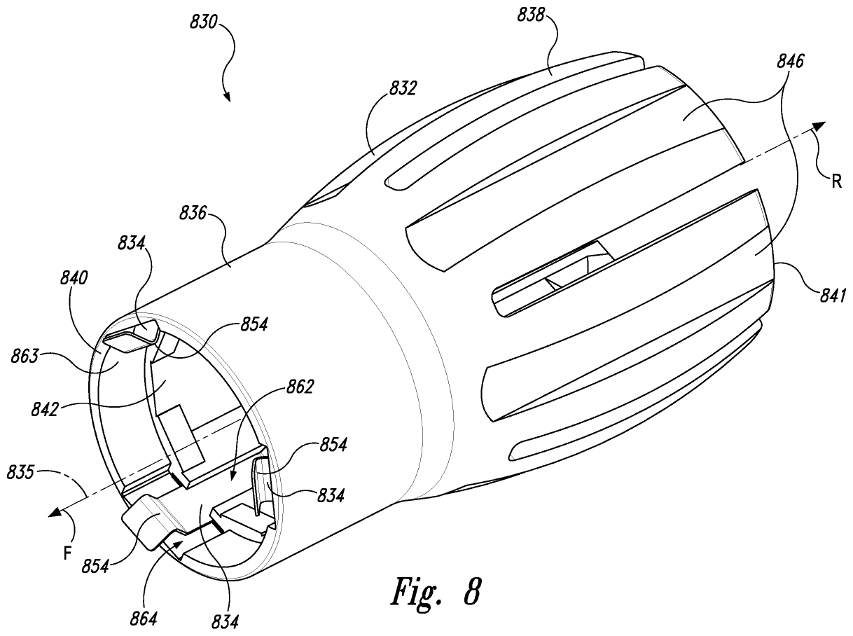

FIG. 7A is a partial cross-sectional side view of the coaxial cable assembly 100 during connection to the female F-connector 120 with the connecting device 230 configured in accordance with an embodiment of the present technology. In FIG. 7A, the jumper sleeve 232 is shown in cross-section for clarity of illustration. FIG. 7B is a side view of the coaxial cable assembly 100 mated to the female F-connector 120 after installation. Referring to FIGS. 7A and 7B together, the male F-connector 102 can be connected to the female F-connector 120 in a generally similar manner as described above with reference to FIG. 1C. However, the grip portion 238 provides a larger outer diameter—and a correspondingly larger surface area—that offers a mechanical advantage compared to the hexagonal surface 110 for manipulating the connecting device 230 to apply increased torque to the rotatable connecting ring 105 of the male F-connector 102 during installation. Thus, the connecting device 230 facilitates a more efficient and secure connection of the male F-connector 102 to the female F-connector 120 than might otherwise be achievable without the connecting device 230.

In the illustrated embodiment, the prongs 250 of the grounding element 234 extend outward beyond the rotatable connecting ring 105 of the male F-connector 102 to conductively contact the female F-connector 120. More specifically, the end portions 254 project outward and radially inward toward the female F-connector 120 and contact the threaded outer surface 122 to maintain a metal-to-metal ground path between the connectors 102, 120. In some embodiments, the apexes 251 of the end portions 254 are received in the grooves of the threaded outer surface 122. In some embodiments, the prongs 250 can be formed with an inward spring bias such that, when the connectors 102, 120 are not attached, a maximum diameter (or other maximum cross-sectional dimension) between the end portions 254 is less than the diameter of the outer surface 122 of the female F-connector 120. As a result, after attachment, the prongs 250 can exert a radially inward spring force against the threaded outer surface 122 to ensure the prongs 250 remain in contact against the female F-connector 120 and to maintain the metal-to-metal ground connection between the connectors 102, 120.

Accordingly, the connecting device 230 of the present technology can maintain ground continuity between the connectors 102, 120 when the connection between the connectors 102, 120 may be less than secure. For example, the prongs 250 of the grounding element 234 conductively contact the female F-connector even when the connection—and therefore the ground path—between the threaded surfaces 108, 122 of the connectors 102, 120, respectively, is less than secure. Moreover, as shown in FIG. 7A, because the prongs 250 extend outwardly beyond the male F-connector 102, the prongs 250 can contact the female F-connector 120 before any portion of the male F-connector 102 contacts the female F-connector 120 during installation. In particular, at least one of the prongs 250 can conductively contact the female F-connector 120 before the central conductor 107 of the coaxial cable 104 contacts the female F-connector 120. Thus, the grounding element 234 can provide a ground path that discharges any built-up capacitive charge in the central conductor 107 before the capacitive charge can be discharged into, for example, the host electrical device coupled to the female F-connector 120.

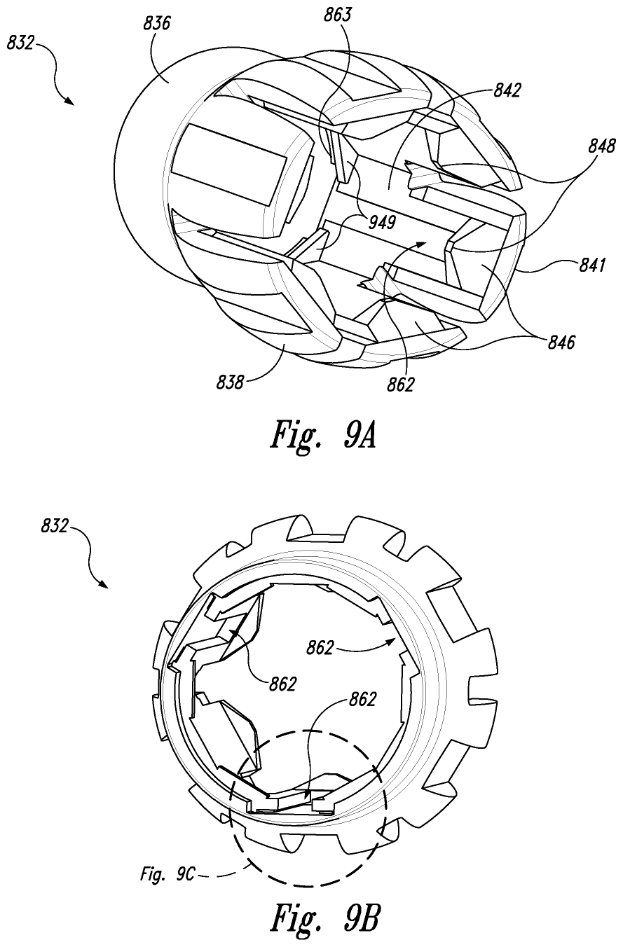

FIG. 8 is an isometric view of a connecting device 830 configured in accordance with another embodiment of the present technology. The connecting device 830 can include some features generally similar to the features of the connecting device 230 described in detail above with reference to FIGS. 2-7B. For example, in the illustrated embodiment, the connecting device 830 includes a hollow gripping member, referred to herein as a jumper sleeve 832, having a central axis 835 and configured to facilitate connection between two coaxial cable connectors. The jumper sleeve 832 includes a wrench portion 836 and a grip portion 838. The wrench portion 836 has a forward edge 840, a first inner surface 842, and a second inner surface 863. The first inner surface 842 is configured (e.g., shaped) to receive and at least partially grip an outer surface of a coaxial cable connector. For example, in the illustrated embodiment, the first inner surface 842 has a complimentary hexagonal shape for snugly receiving the hexagonal surface 110 of the connecting ring 105 shown in FIG. 1A. In other embodiments, the first inner surface 842 can have other shapes and features to facilitate receiving and/or gripping coaxial cable connectors having different shapes. As described in further detail below, the grip portion 838 extends from the wrench portion 836 toward a rear edge 841, and can have one or more grip members 846. The grip members 846 extend axially away from the wrench portion in a direction R, and can provide a gripping surface for applying torque to the rotatable connecting ring 105 of the male F-connector 102 received in the wrench portion 836.

As further illustrated in FIG. 8, the jumper sleeve 832 includes a plurality of (e.g., three) first recesses (e.g., grooves, channels, slots, etc.) 862 extending generally parallel to the central axis 835 and at least partially through (e.g., formed in, defined by, etc.) the first inner surface 842. The jumper sleeve 832 further includes a plurality of second recesses (e.g., grooves, channels, slots, etc.) 864 extending at least partially through (e.g., formed in, defined by, etc.) the second inner surface 863. As shown in the embodiment of FIG. 8, the first recesses 862 can be aligned with corresponding ones of the second recesses 864 and can be equally spaced around the central axis 835. Moreover, in some embodiments, the second recesses 864 can extend farther circumferentially about the central axis 835 than the first recesses 862.

The connecting device 830 also includes one or more (e.g., three) grounding elements 834 that can be removably or permanently installed at least partially within the jumper sleeve 832. The grounding elements 834 are made from a conductive material (e.g., a conductive resilient material such as copper beryllium) and each have an elongate body that extends outward in a direction F at least partially beyond the first inner surface 842 of the wrench portion 836. In some embodiments, each of the grounding elements 834 can also include an end portion 854 that extends outwardly at least partially beyond the forward edge 840 of the jumper sleeve 832. In other embodiments, the connecting device 830 can include a different number of grounding elements 834 (e.g., one grounding element, two grounding elements, four grounding elements, six grounding elements, etc.).

Each grounding element 834 is received and/or secured at least partially within corresponding pairs of the recesses 862, 864. In particular, the elongate body of each grounding element 834 can extend generally parallel to the central axis 835 of the jumper sleeve 832, and the end portion 854 (e.g., an engagement portion) can extend beyond the first inner surface 842 and radially inward toward the central axis 835. When the connecting device 830 is used to connect the male F-connector 102 to the female F-connector 120, as described below, at least a portion of each grounding element 834 conductively contacts at least a portion of the male F-connector 102, and the grounding elements 834 conductively contact at least a portion of the female F-connector 120 to maintain ground path continuity between the two connectors 102, 120.

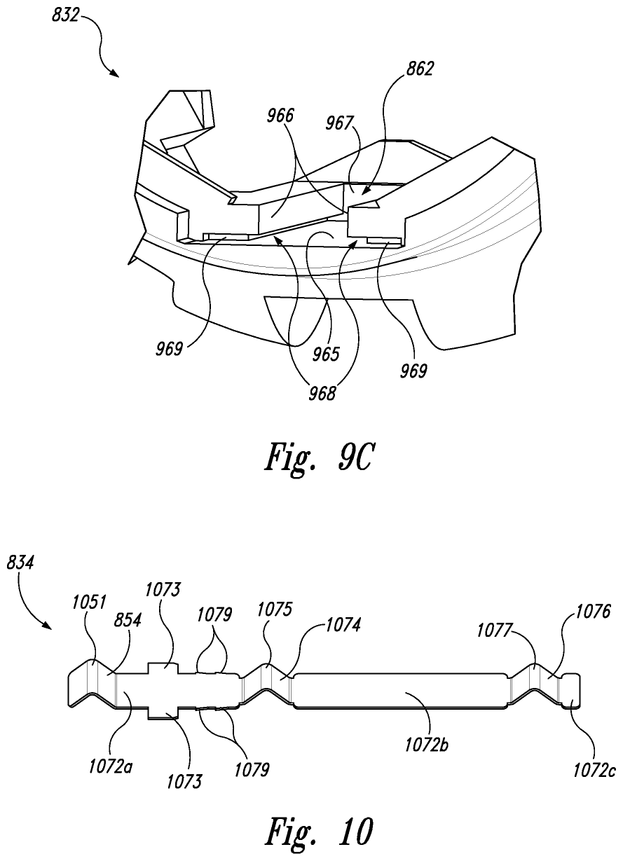

FIGS. 9A and 9B are rear and front isometric views, respectively, of the jumper sleeve 832 prior to installation of the grounding elements 834. The jumper sleeve 832 can include some features generally similar to the features of the jumper sleeve 232 described in detail above with reference to FIG. 3. For example, referring to FIG. 9A, in the illustrated embodiment the grip portion 238 has a cask-shape with a plurality of (e.g., six) convex grip members 846 extending outwardly from the wrench portion 836. For example, the grip members 846 can be cantilevered from the wrench portion 836. In other embodiments, the grip portion 838 can include one or more grip members 846 having different shapes (e.g., concave, angular, etc.), and/or fewer or more than the six grip members 846 shown in FIG. 9A. In some embodiments, individual grip members 846 can be omitted, and instead the grip portion 838 can include a single (e.g., cylindrical, conical, etc.) member. When the male F-connector 102 (FIG. 1A) is inserted into the jumper sleeve 832, the grip members 846 allow for application of a greater torque to the rotatable connecting ring 105 than could otherwise be achieved by direct manual rotation of the hexagonal surface 110 of the male F-connector 102.

In the embodiment illustrated in FIG. 9A, the grip members 846 each include a key portion 848 projecting inward toward the central axis 835 (FIG. 8). In some embodiments, the key portions 848 are positioned proximate the rear edge 841 of the grip member 838. The key portions 848 are configured to abut a portion of the male F-connector 102 (e.g., a rear edge of the sleeve 112) to retain the male F-connector 102 in the jumper sleeve 832 and to inhibit the male F-connector 102 from moving out of the jumper sleeve 832 in the direction R (FIG. 8). Similarly, one or more shoulder portions 949 can bridge between adjacent “flats” of the first (e.g., hexagonal) inner surface 842 proximate to the second inner surface 863, and are configured to abut a forward edge of the hexagonal surface 110 (e.g., a shoulder between the first outer surface portion 106 and the hexagonal surface 110) of the connecting ring 105 to inhibit the male F-connector 102 from moving out of the jumper sleeve 832 in the direction F (FIG. 8).

As further illustrated in the embodiment of FIG. 9A, the first recesses 862 can extend from the first inner surface 842 of the wrench portion 836 and at least partially along corresponding ones of the grip members 846 toward the rear edge 841 of the grip portion 838. In some embodiments, as illustrated in FIG. 9B, the jumper sleeve 832 can include three first recesses 862 (e.g., a number corresponding to the number of grounding elements 834), and the first recesses 862 can generally extend along alternating ones of the six grip members 846. In other embodiments, the first recesses 862 can have other configurations (e.g., spacing, relative length, number, etc.) and/or shapes other than rectangular (e.g., sinusoidal, oval, etc.). As described in further detail below, the first recesses 862 are configured (e.g., rectangularly shaped and sized) to receive and retain the grounding elements 834 therein.

For example, FIG. 9C is an enlarged, front isometric view of the jumper sleeve 832 showing one of the first recesses 862. In the illustrated embodiment, the first recess 862 can be defined by (i) opposing securing features (e.g., sidewalls, lips, overhang portions, etc.) 966, (ii) opposing outer shoulder portions 969, (iii) an inner surface 965, and/or (iii) an end wall 967. The securing features 966 can project toward each other beyond the outer shoulder portions 969 to define overhang regions 968 between the securing features 966 and the inner surface 965. That is, a distance (e.g., width) between the securing features 966 can be less than a distance (e.g., width) between the outer shoulder portions 969. In some embodiments, the jumper sleeve 832 can be made from, for example, plastic, rubber, metal, and/or other suitable materials using methods well known in the art.

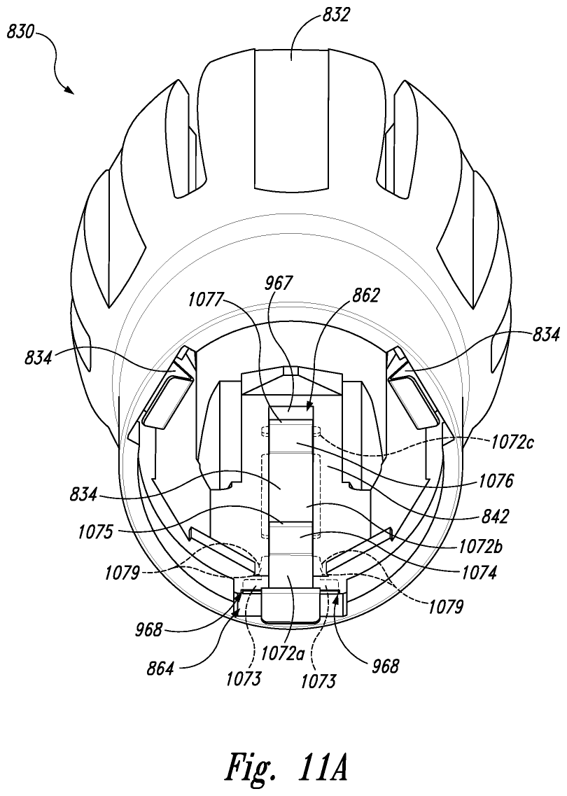

FIG. 10 is an isometric view of one of the grounding elements 834 configured in accordance with an embodiment of the present technology. While only one grounding element 834 is shown in FIG. 10, as noted above, the connecting device 830 can include one or more grounding elements 834. In some embodiments, the individual grounding elements 834 can be generally similar (e.g., identical) while, in other embodiments, the individual grounding elements 834 can have different configurations. In further embodiments, two or more of the grounding elements 834 can be connected together via a base or other portion or they can be separate as shown in FIG. 10.

In the illustrated embodiment, the grounding element 834 includes (i) the end portion 854, (ii) body portions 1072 (referred to individually as first, second, and third body portions 1072a, 1072b, and 1072c, respectively), (iii) a first contact feature 1074 extending between the first and second body portions 1072a, 1072b, and (iv) a second contact feature 1076 extending between the second and third body portions 1072b, 1072c. As described in further detail below, the body portions 1072 are configured to be snugly (e.g., closely) fitted and/or slidably received at least partially within one of the first recesses 862 of the jumper sleeve 832 and, in some embodiments, the first body portion 1072a can include one or more projections or flanges 1073 and/or teeth 1079 configured to help retain and/or secure the grounding element 834 within the first recess 862 of the jumper 832.

Each of the end portion 854, the first contact feature 1074, and the second contact feature 1076 are shaped (e.g., bent or otherwise formed) to extend inwardly relative to axis 835 (FIG. 8). In some embodiments, the end portion 854 can have an angled or chevron-like profile including a rounded apex 1051 that is configured to contact or engage the threaded outer surface 122 of the female F-connector 120 (FIG. 1B). Similarly, the first contact feature 1074 can have an angled or chevron-like shape including an apex 1075 that is configured to contact or engage a portion of (e.g., the hexagonal surface 110) of the rotatable connecting ring 105 of the male F-connector 102 (FIG. 1A). The second contact feature 1076 can also have an angled or chevron-like shape including an apex 1077 that is configured to contact or engage the outer surface 113 of the sleeve 112 of the rotatable connecting ring 105 of the male F-connector 102 (FIG. 1A).

In some embodiments, the grounding elements 834 can be formed from any suitable conductive material (e.g., a metallic material) such as, for example, copper beryllium, brass, phosphor bronze, stainless steel, etc., and can have any suitable thickness. For example, in some embodiments, the grounding elements 834 can have a thickness of from about 0.001 inch to about 0.032 inch, or about 0.003 inch to about 0.020 inch. In some embodiments, the grounding elements 834 can be formed from a resilient conductive material that is suitably elastic to flex in response to external forces experienced in use.

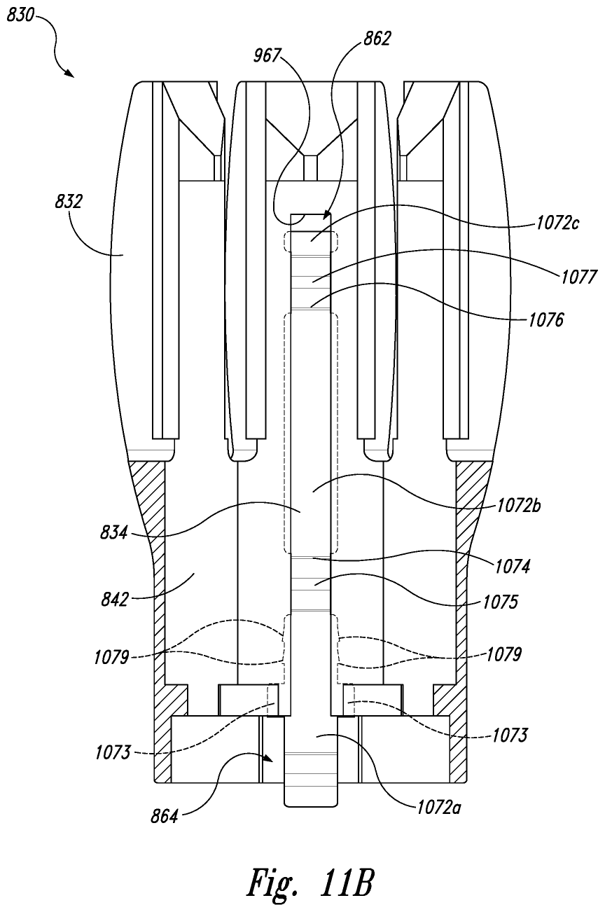

FIG. 11A is a front isometric view, and FIG. 11B is a top cross-sectional view, of the connecting device 830 showing the grounding element 834 installed within the jumper sleeve 832. In FIGS. 11A and 11B, the jumper sleeve 832 is shown as partially transparent for clarity of illustration. Referring to FIGS. 11A and 11B together, in the illustrated embodiment, each of the grounding elements 834 is installed within corresponding pairs of the recesses 862, 864. For example, in some embodiments, the third body portion 1072c of each of the grounding elements 834 can be aligned with one of the second recesses 864, and then moved axially (e.g., pushed) in the direction R (FIG. 8) through the second recess 864 and into a corresponding one of the first recesses 862. The grounding elements 834 can be moved axially in the direction R until the flanges 1073 abut the outer shoulder portions 969 (best seen in FIG. 9B) of the jumper sleeve 832 and/or the third body portions 1072c abut the end walls 967 of the jumper sleeve 832, which inhibits the grounding elements 834 from moving farther in the direction R and facilitates suitable positioning of the grounding elements 834 within the jumper sleeve 832 (e.g., relative to the later installed male F-connector 102). In certain embodiments, the third body portion 1072c of each grounding element 834 is spaced apart from the end wall 967 prior to installation of the male F-connector 102. As further illustrated in the embodiment of FIGS. 11A and 11B, the body portions 1072 of the grounding elements 834 can extend at least partially into the overhang regions 968 of the jumper sleeve 832 to inhibit the grounding elements 834 from moving radially inward toward the central axis 835 (FIG. 8).

Likewise, in some embodiments, the teeth 1079 of the grounding 834 are shaped to inhibit movement of the grounding elements 834 in the direction F (FIG. 8) once the teeth 1079 are positioned within the first recess 862. For example, in certain embodiments, the teeth 1079 can engage (e.g., “bite into”) the outer shoulder portions 969 when the grounding elements 834 are moved (e.g., pulled) in the direction F (FIG. 8). Accordingly, in some embodiments, the grounding elements 834 are permanently or semi-permanently installed within the jumper sleeve 832. In other embodiments, the grounding elements 834 can be releasably secured within the jumper sleeve 832 (e.g., the grounding elements 834 need not include the teeth 1079 or other similar features). In yet other embodiments, the grounding elements 834 can be secured within the jumper sleeve 832 via other means. For example, the grounding elements 834 can be cast into, adhesively bonded, welded, fastened, and/or otherwise integrated or attached to the jumper sleeve 832 during or after manufacture.

In the illustrated embodiment, the grounding elements 834 are equally spaced angularly around the central axis 835 (FIG. 8) of the jumper sleeve 832. Such a configuration can maximize the likelihood that ground continuity will be maintained between the connectors 102, 120 once they are connected using the connecting device 830, since any radial misalignment between the connectors 102, 120 will necessarily be towards at least one of the grounding elements 834. However, in some embodiments, the grounding elements 834 can have a different configuration (e.g., six grounding elements 834 each positioned within a corresponding first recess 862 extending along one of the six grip members 846, only a single grounding element 834 positioned within a first recess 862 extending along one of the six grip members 846, etc.).

In some embodiments, after installation into the jumper sleeve 832, the first and second contact features 1074, 1076 (collectively “contact features 1074, 1076”) can project inwardly from the first recesses 862 (e.g., extend inward beyond the first inner surface 842) such that the apex 1075 of the first contact feature 1074 and the apex 1077 of the second contact feature 1076 are positioned to conductively contact the male F-connector 102 (FIG. 1A) when it is installed within the jumper sleeve 832. In certain embodiments, where the grounding elements 834 are made of a resilient conductive material, the contact features 1074, 1076 can flex outward when the male F-connector 102 is installed within the jumper sleeve 832. In some such embodiments, the contact features 1074, 1076 can correspondingly lengthen (e.g., flatten out in a direction parallel to the central axis 835) and/or the apexes 1075, 1077 can be forced outwardly until they are at least partially or generally coplanar with the first inner surface 842.

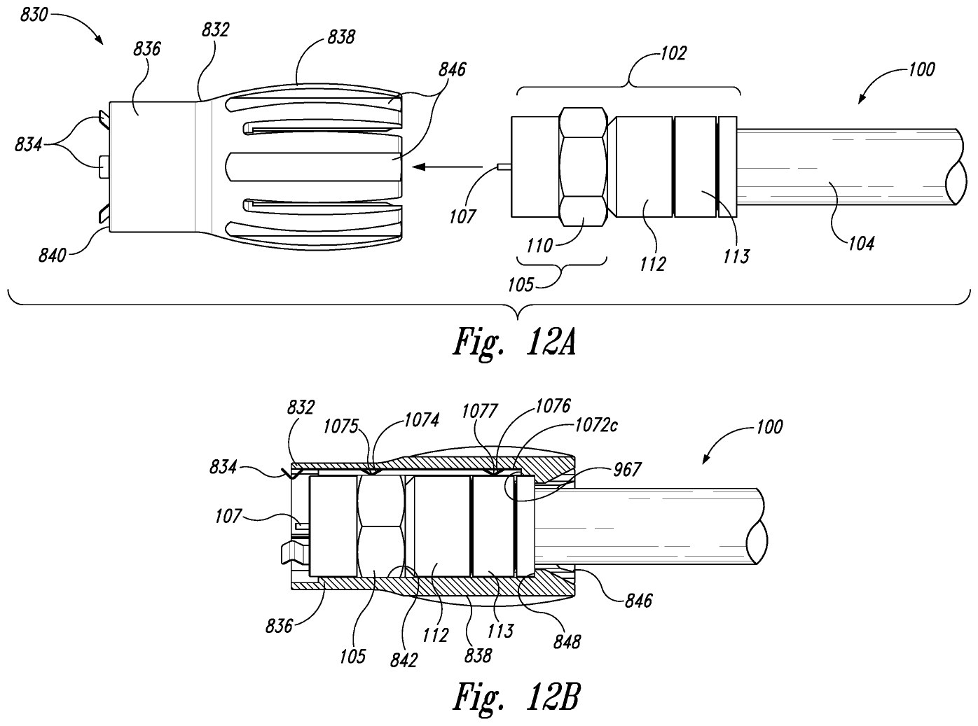

FIG. 12A is a side view of the coaxial cable assembly 100 and connecting device 830 prior to installation of the connecting device 830 onto the coaxial cable assembly 100. FIG. 12B is a side view of the coaxial cable assembly 100 and the connecting device 830 after installation of the connecting device 830. In FIG. 12B, the connecting device 830 is shown in cross-section for clarity of illustration. Referring to FIGS. 12A and 12B together, during installation, the male F-connector 102 is fully inserted into the connecting device 830 so that the first inner surface 842 of the wrench portion 836 receives the hexagonal surface 110 of the connecting ring 105. In some embodiments, the grip members 846 of the grip portion 838 can be flexed outward to allow the male F-connector 102 to be positioned within the connecting device 830. When the male F-connector 102 is fully inserted, the key portions 848 and the shoulder portions 949 (obscured in FIG. 12B; illustrated in FIG. 9A) retain the male F-connector 102 in the connecting device 830.

As best seen in FIG. 12B, the grounding elements 834 are positioned between the jumper sleeve 832 and the sleeve 112 and the connecting ring 105 of the male F-connector 102. More particularly, in some embodiments, the apex 1075 of the first contact feature 1074 of each grounding element 834 conductively engages (e.g., contacts) a corresponding one of the “flats” of the hexagonal surface 110 of the connecting ring 105 while the apex 1077 of the second contact feature 1076 conductively engages (e.g., contacts) the outer surface 113 of the sleeve 112. Accordingly, each grounding element 834 is configured to maintain a metal-to-metal ground path throughout the male F-connector 102.

As described above, in some embodiments, the contact features 1074, 1076 can be forced to flex radially outwardly when the male F-connector 102 is installed within the jumper sleeve 832. In such embodiments, the contact features 1074, 1076 can exert a biasing force against the male F-connector 102 to provide a secure engagement (e.g., contact) between the grounding elements 834 and the male F-connector 102. In some such embodiments, the contact features 1074, 1076 can correspondingly lengthen (e.g., flatten out) slightly such that the grounding elements 834 have an increased overall length. In the illustrated embodiment, the connecting device 830 is configured such that the third body portions 1072c of the grounding elements 834 are positioned proximate to (e.g., abut against) the end walls 967 after the male-F connector 102 is installed. Additionally, in the illustrated embodiment, each of the grounding elements 834 extends beyond the forward edge 840 of the wrench portion 836, while the central conductor 107 of the coaxial cable 104 does not extend beyond the forward edge 840 of the wrench portion 836.

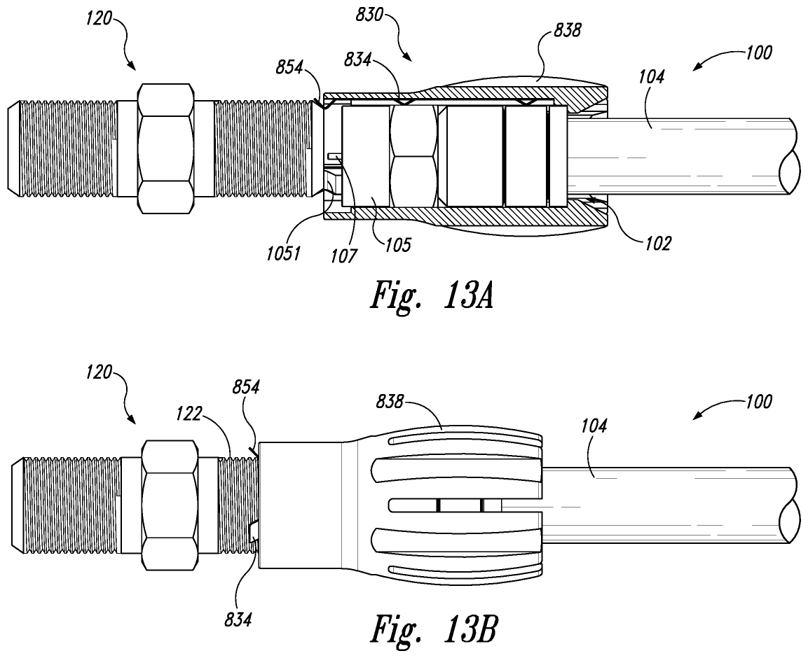

FIG. 13A is a partial cross-sectional side view of the coaxial cable assembly 100 during connection to the female F-connector 120 with the connecting device 830 configured in accordance with an embodiment of the present technology. In FIG. 13A, the connecting device 830 is shown in cross-section for clarity of illustration. FIG. 13B is a side view of the coaxial cable assembly 100 mated to the female F-connector 120 after installation. Referring to FIGS. 13A and 13B together, the male F-connector 102 can be connected to the female F-connector 120 in a generally similar manner as described above with reference to FIG. 1C. However, the grip portion 838 provides a larger outer diameter—and a correspondingly larger surface area—that offers a mechanical advantage compared to the hexagonal surface 110 for manipulating the connecting device 830 to apply increased torque to the rotatable connecting ring 105 of the male F-connector 102 during installation. Thus, the connecting device 830 facilitates a more efficient and secure connection of the male F-connector 102 to the female F-connector 120 than might otherwise be achievable without the connecting device 830.

In the illustrated embodiment, the grounding elements 834 extend outward beyond the rotatable connecting ring 105 of the male F-connector 102 to conductively contact the female F-connector 120. More specifically, the end portions 854 project outward and radially inward toward the female F-connector 120 and contact the threaded outer surface 122 of the female F-connector 120 to maintain a metal-to-metal ground path between the connectors 102, 120. In some embodiments, the apexes 1051 of the end portions 854 are received in the grooves of the threaded outer surface 122. In some embodiments, all or a portion (e.g., the end portions 854, the first body portions 1072a, etc.) of the grounding elements 834 can be formed with an inward spring bias such that, when the connectors 102, 120 are not attached, a maximum diameter (or other maximum cross-sectional dimension) between the end portions 854 is less than the diameter of the outer surface 122 of the female F-connector 120. As a result, after attachment, the grounding elements 834 can exert a radially inward spring force against the threaded outer surface 122 to ensure that the grounding elements 834 remain in contact against the female F-connector 120 and to maintain the metal-to-metal ground connection between the connectors 102, 120.

Accordingly, the connecting device 830 of the present technology can maintain ground continuity between the connectors 102, 120 when the connection between the connectors 102, 120 may be less than secure. For example, the grounding elements 834 conductively contact the female F-connector 120 even when the connection—and therefore the ground path—between the threaded surfaces 108, 122 of the connectors 102, 120, respectively, is less than secure. Moreover, as shown in FIG. 13A, because the grounding elements 834 extend outwardly beyond the male F-connector 102, the grounding elements 834 can contact the female F-connector 120 before any portion of the male F-connector 102 contacts the female F-connector 120 during installation. In particular, at least one of the grounding elements 834 can conductively contact the female F-connector 120 before the central conductor 107 of the coaxial cable 104 contacts the female F-connector 120. Thus, the grounding element 834 can provide a ground path that discharges any built-up capacitive charge in the central conductor 107 before the capacitive charge can be discharged into, for example, the host electrical device coupled to the female F-connector 120.

The foregoing description of embodiments of the technology is not intended to be exhaustive or to limit the disclosed technology to the precise embodiments disclosed. While specific embodiments of, and examples for, the present technology are described herein for illustrative purposes, various equivalent modifications are possible within the scope of the present technology, as those of ordinary skill in the relevant art will recognize. For example, although certain functions may be described in the present disclosure in a particular order, in alternate embodiments these functions can be performed in a different order or substantially concurrently, without departing from the spirit or scope of the present disclosure. In addition, the teachings of the present disclosure can be applied to other systems, not only the representative connectors described herein. Further, various aspects of the technology described herein can be combined to provide yet other embodiments.

All of the references cited herein are incorporated in their entireties by reference. Accordingly, aspects of the present technology can be modified, if necessary or desirable, to employ the systems, functions, and concepts of the cited references to provide yet further embodiments of the disclosure. These and other changes can be made to the present technology in light of the above-detailed description. In general, the terms used in the following claims should not be construed to limit the present technology to the specific embodiments disclosed in the specification, unless the above-detailed description explicitly defines such terms. Accordingly, the actual scope of the disclosure encompasses the disclosed embodiments and all equivalent ways of practicing or implementing the disclosure under the claims.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below,” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list, and any combination of the items in the list.

From the foregoing, it will be appreciated that specific embodiments of the disclosed technology have been described herein for purposes of illustration, but that various modifications may be made without deviating from the present technology. Certain aspects of the disclosure described in the context of particular embodiments may be combined or eliminated in other embodiments. Further, while advantages associated with certain embodiments of the disclosed technology have been described in the context of those embodiments, other embodiments may also exhibit such advantages, and not all embodiments need necessarily exhibit such advantages to fall within the scope of the disclosed technology. Accordingly, the disclosure and associated technology can encompass other embodiments not expressly shown or described herein. The following examples are directed to embodiments of the present disclosure.

1-20. (canceled)

21. A device for attaching a first coaxial cable connector to a second coaxial cable connector, the first coaxial cable connector having a threaded connecting ring configured to mate to the second coaxial cable connector, the device comprising:
a gripping member configured to operably receive at least a portion of the first coaxial cable connector; and
a grounding element at least partially disposed in the gripping member, wherein the grounding element includes a base portion and a plurality of prongs extending from the base portion, wherein the prongs define a forward end portion of the grounding element, and wherein, when the first coaxial cable connector is operably received by the gripping member
the base portion is configured to extend at least partially about and conductively contact the connecting ring, and
the prongs are configured to extend from the base portion beyond an outer edge of the connecting ring.

22. The device of claim 21 wherein the base portion is configured to extend circumferentially about a perimeter of the connecting ring when the first coaxial cable connector is operably received by the gripping member.

23. The device of claim 22 wherein the base portion extends only partially about the perimeter of the connecting ring when the first coaxial cable connector is operably received by the gripping member.

24. The device of claim 21 wherein the prongs extend generally orthogonal to the base portion.

25. The device of claim 21 wherein the prongs define a forwardmost end of the grounding element.

26. The device of claim 21 wherein the plurality of prongs include three or more prongs.

27. The device of claim 21 wherein the grounding element is configured to conductively contact the second coaxial cable connector when the connecting ring is mated to the second coaxial cable connector.

28. The device of claim 21 wherein the prongs are configured to engage a threaded exterior surface of the second coaxial cable connector when the connecting ring is mated to the second coaxial cable connector.

29. The device of claim 21 wherein the grounding element is formed from a resilient conductive material, and wherein the prongs are configured to exert a radially inward spring force against an outer surface of the second coaxial cable connector when the connecting ring is mated to the second coaxial cable connector.

30. The device of claim 21 wherein the first coaxial cable connector includes a central conductor projecting forward beyond the outer edge of the connecting ring, and wherein the prongs are configured to extend at least partially farther forward than the central conductor when the first coaxial cable connector is operably received by the gripping member.

31. The device of claim 21 wherein the first coaxial cable connector is a male F-connector and wherein the second coaxial cable is a female F-connector.

32. The device of claim 21 wherein the gripping member includes a forward edge, and wherein the prongs extend at least to the forward edge.

33. The device of claim 21 wherein the each of the prongs includes a distal end portion, and wherein the distal end portions of the prongs define the forward end portion of the grounding element.

34. A method of attaching a first coaxial cable connector to a second coaxial cable connector, the first coaxial cable connector having a threaded connecting ring configured to mate to the second coaxial cable connector, the method comprising:
positioning a grounding element in a gripping member, wherein the gripping member includes a forward edge and is configured to operably receive a portion of the first coaxial cable connector, wherein the grounding element includes a base portion and a plurality of prongs extending from the base portion, wherein the prongs define a forward end portion of the grounding element, wherein positioning the grounding element in the gripping member includes positioning the grounding element such that the prongs extend axially toward the forward edge of the gripping member, and wherein, when the first coaxial cable connector is operably received by the gripping member
the base portion is configured to extend at least partially about and conductively contact the connecting ring, and
the prongs are configured to extend from the base portion beyond an outer edge of the connecting ring.

35. The method of claim 34 wherein the base portion extends only partially about the perimeter of the connecting ring when the first coaxial cable connector is operably received by the gripping member.

36. The method of claim 34 wherein the method further comprises installing the gripping element and the grounding element on the first coaxial cable connector such that
the gripping member operably receives the portion of the of coaxial cable connector;
the base portion extends at least partially about and conductively contact the connecting ring; and
the prongs extend from the base portion beyond an outer edge of the connecting ring.

37. The method of claim 34 wherein the method further comprises attaching the first coaxial cable connector to the second coaxial connector.

38. A connecting device, comprising:
a hollow member configured to receive a coaxial cable connector having a rotatable ring and a central conductor, wherein the hollow member includes an inner surface having a plurality of recesses formed therein; and
a plurality of grounding elements secured in corresponding ones of the recesses such that, when the hollow member receives the coaxial cable connector, the grounding elements are configured to conductively contact the rotatable ring and axially extend beyond the central conductor.

39. The connecting device of claim 38 wherein the plurality of grounding elements include three elongate grounding elements that are equally spaced circumferentially about a longitudinal axis of the hollow member, wherein the coaxial cable connector is a first coaxial cable connector, and wherein the grounding elements are configured to conductively contact an outer surface of a second coaxial cable connector when the first coaxial cable connector is mated to the second coaxial cable connector.

40. The connecting device of claim 38 wherein the coaxial cable connector is a first coaxial cable connector, wherein the grounding elements each include an end portion positioned axially beyond the central conductor of the first coaxial cable connector, wherein the grounding elements are formed of a resilient material, and wherein a maximum diameter between the end portions is less than a diameter of an outer surface of a second coaxial cable connector configured to be mated to the first coaxial cable connector.
